(19) United States
(12) Patent Application Publication
(10) Pub. No.: US 2012/0066831 A1
(43) Pub. Date: Mar. 22, 2012

(54) PATIENT TRANSFER APPARATUS

(76) Inventor: YangGyu Jei, GyeongSangBukDo (KR)

(21) Appl. No.: 13/322,552

(22) PCT Filed: Jun. 14, 2010
(86) PCT No.: PCT/KR2010/003795

§ 371 Date: Nov. 26, 2011

(30) Foreign Application Priority Data
Jun. 16, 2009 (KR) 1020090053325

(51) Int. Cl. A61G 7/10

(52) U.S. Cl. 5/81.1 R

(57) ABSTRACT

A patient transfer apparatus of the present invention is configured in that a top movable board of a patient movable bed is easily movable onto a patient bed mattress by using a transfer arm and a wheeled chassis moving on the transfer arm, so as to cause minimum inconveniences to a patient and allow for a transfer with ease when the patient who is not able to move freely is transferred between the patient bed and the patient movable bed. In addition, a linkage device is installed beneath the top movable board to easily incline the top movable board toward the body of the patient. Therefore, the patient can be taken onto or removed from the patient movable bed merely by lying on his/her side from the posture of lying on his/her back, thereby minimizing inconvenience to the patient caused by a patient transfer, and enabling the patient transfer to be easily performed with a smaller number of people. Further, the patient transfer apparatus of the present invention eliminates the necessity of external power source for patient transfer, and has the advantages of a simple configuration and reduced cost.

### TECHNICAL FIELD

The present invention relates to a patient transfer apparatus generally used for a patient transfer between a patient bed and a patient movable bed or a patient transfer between a patient movable bed and various medical diagnosis apparatuses, by which it is possible to easily transfer a patient without causing inconveniences to the patient when transferring a patient, who is very weak to move for himself, between a patient bed and a patient movable bed.

### BACKGROUND ART

Lots of patient transfer apparatus are being filed and are already registered as patents in advanced countries including the USA whereas less patents are disclosed in Korea. The inventions in foreign countries which are being filed or are already registered as patents are formed of complicated parts and are very hard to use, as a result of which actual applications are very limited. For example, the apparatuses of U.S. Pat. No. 7,000,268, U.S. Pat. No. 5,937,456, U.S. Pat. No. 4,873,732, U.S. Pat. No. 4,274,168, etc. are directed to using relatively complicated parts and are expensive, and the installations need lot of hard work, which results in limited use.

The apparatus of the U.S. Pat. No. 4,259,756 has a simple structure and easier installation and operation; however when a patient lies down on a top movable board, the top movable board does not move easily due to a large friction force between a top movable board and a patient bed mattress due to a patient's body weight. When a patient remains lain down on a top movable board, a top movable board does not easily move between a patient bed and a patient movable bed because a friction force is large between a top movable board and a patient bed mattress. In order to overcome the above problems, the U.S. Pat. No. 7,000,268 has introduced a new feature called a transfer arm which is designed to help easily move a top movable board on a patient bed. The above patent however needs a complicated procedure for installing and withdrawing the transfer arm. Rollers are further installed at a bottom of a transfer arm to help the transfer arm to move easily on the patient bed. The installations of the roller cause the wide intervals from the patient bed mattress to the top movable board, thus resulting in lots of inconveniences when a patient's back is helped to stand upright, and a patient lies down on a top movable board from a patient bed.

### DISCLOSURE OF INVENTION

Accordingly, it is an object of the present invention to provide a patient transfer apparatus which does not use an external driving force and gives least inconveniences to a patient. The patient can be easily transferred in safe with a small number of people and the installation and operation of the patent transfer apparatus are easy.

To achieve the above objects, there is provided a patient transfer apparatus in which a top movable board 10 of a patient movable bed on which a patient lies down is constituted to easily move on a patient bed mattress by using a transfer arm 30 and a wheeled chassis 20 when a patient is transferred from a patient bed to a patient movable bed without a complicated installation procedure and withdrawal procedure of an additional apparatus. And a linkage 40 is installed beneath a top movable board 10, thus tilting a top movable board 10 in a lateral direction so that a patient can be easily loaded onto or unloaded from a top movable board 10.

### ADVANTAGEOUS EFFECTS

There are lots of occasions that a patient is transferred from a patient bed to a patient movable bed in order to transfer a patient from a patient's room to a diagnosis room or a checking room. Sometimes it needs to move a patient from a patient movable bed to diverse checking apparatuses such as a X-ray examination machine, a MRI machine or the like. Whenever a patient is moved in such a way, the patient feels pains, and multiple persons are needed to help the patient. In recent years, obesity persons increase day by day, so it is very hard to transfer heavy patients.

The present invention is advantageous because a patient can easily get on or off a patent transfer bed in such a manner that a patient is helped to just turn over from a lain-down posture to a posture of lying on his side, thus minimizing any inconveniences occurring during a patient's transfer, and it is possible to easily move a patient with a small number of persons.

In particular, an external driving force is not needed during a patient's transfer in the present invention, and an operation is easy because the present invention does not need an installation and withdrawal procedure of additional apparatuses. The construction of the apparatus is simple, and the apparatus of the present invention is not costly.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating a patient movable bed (front side).

FIG. 2 is a schematic view illustrating a patient movable bed (back side).

FIG. 3 is a view illustrating a construction of a transfer arm.

FIG. 4 is a front view illustrating a transfer arm.

FIG. 5 is a side view illustrating a transfer arm.

FIG. 6 is a view illustrating an operation of a transfer arm.

FIG. 7 is a view illustrating a construction of a wheeled chassis and a linkage.

FIG. 8 is a view illustrating a transfer arm cover.

FIG. 9 is a view illustrating a step that a patient is loaded onto a patient movable bed.

FIG. 10 is a view illustrating a step that a patient is unloaded from a patient movable bed (method 1).

FIG. 11 is a view illustrating a step that a patient is unloaded from a patient movable bed (method 1).

FIG. 12 is a view illustrating a construction of a side protection rail.

FIG. 13 is a view illustrating a lifting of top movable board driving part.

### MODES FOR CARRYING OUT THE INVENTION

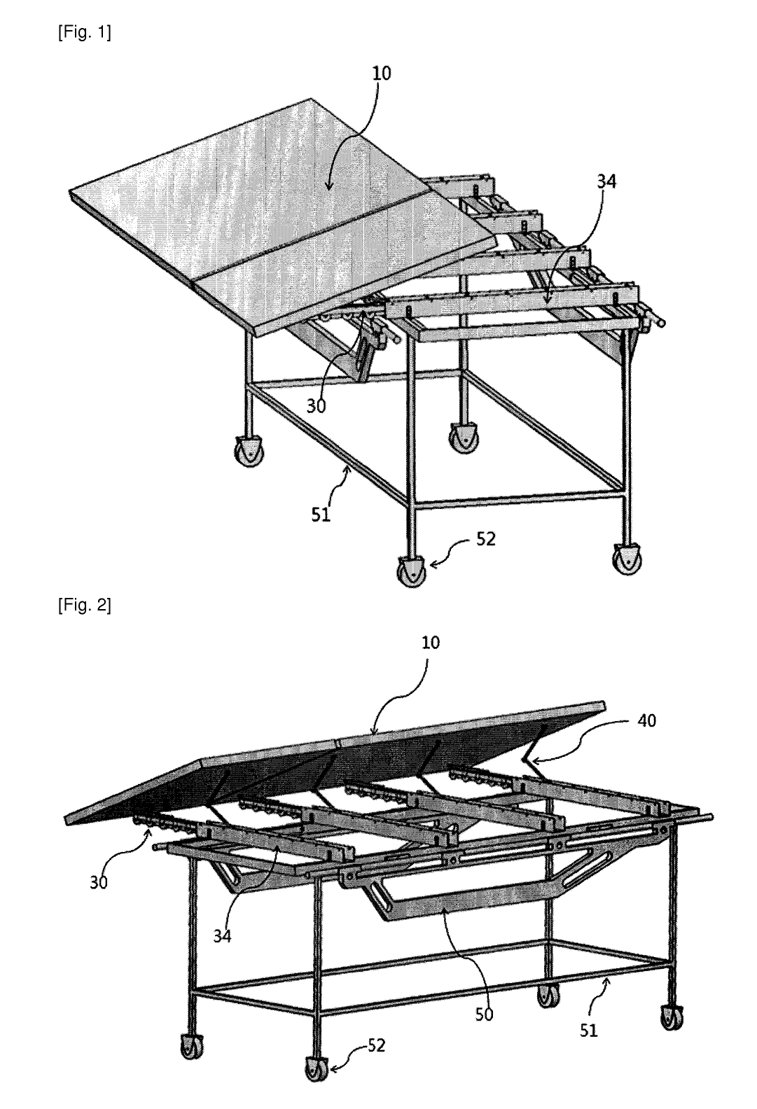

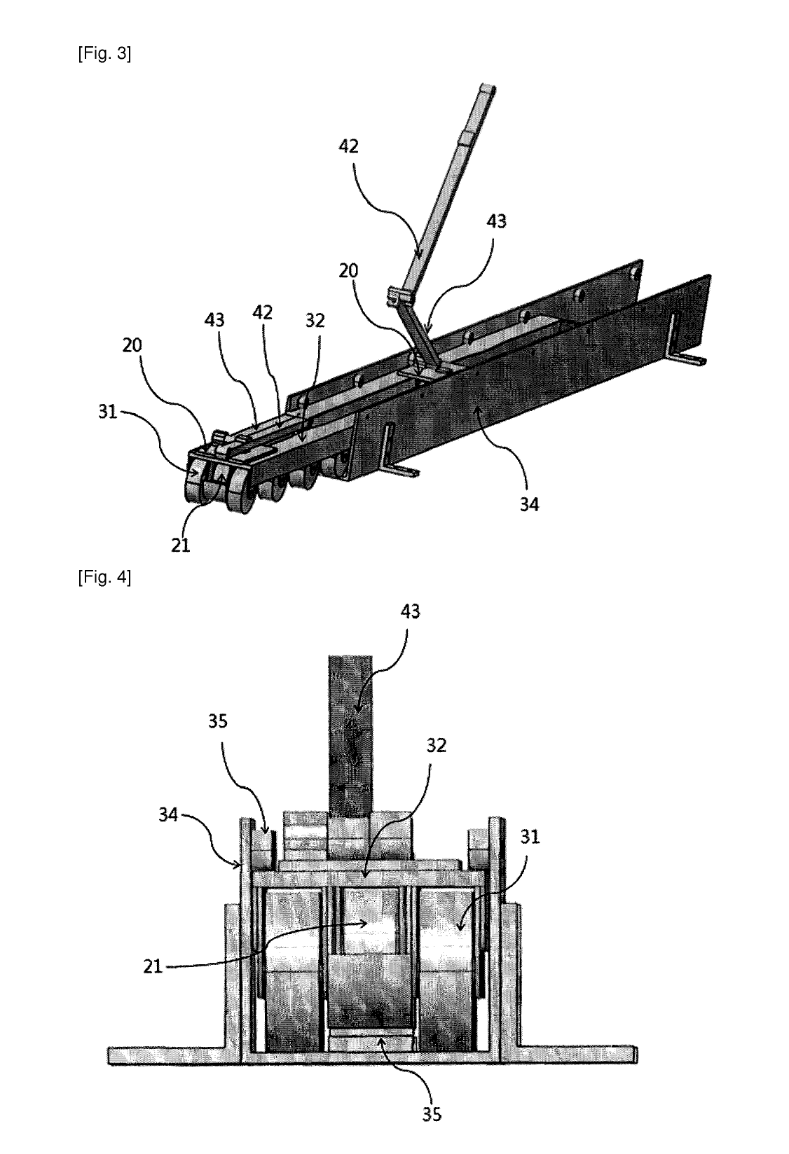

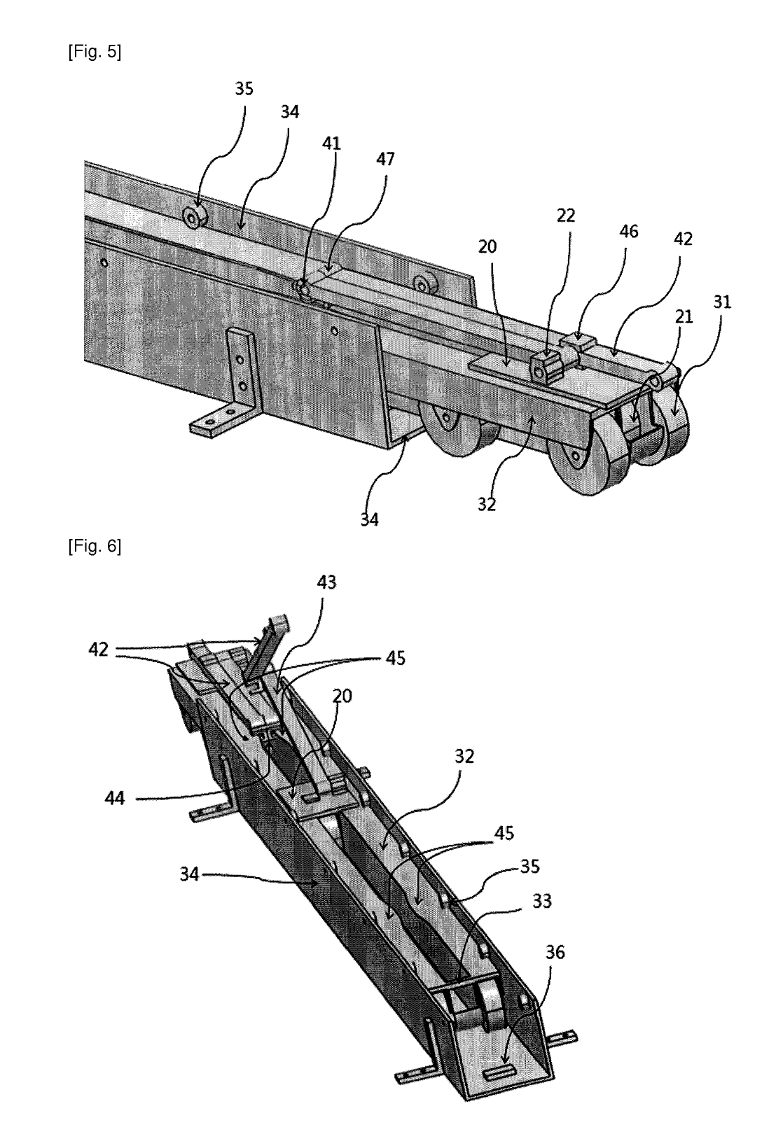

As shown in FIGS. 1 and 2, a transfer arm 30 with rollers is installed beneath a top movable board in order to easily load a top movable board 10 of a patient movable bed onto a patient bed during a transfer of a patient. The top movable board 10 is not directly connected with a transfer arm 30, but is directly connected in such a manner that a wheeled chassis 20 of FIG. 3 is directly connected to the top movable board 10 via a linkage 40 in order for the top movable board 10 to easily move along the transfer arm 30. As shown in FIGS. 4, 5 and 7, the wheeled chassis 20 is equipped with the rollers 21, so when the top movable board 10 moves, the wheeled chassis 20 fixed at the top movable board 10 move along the transfer arm 30 via a wheeled chassis guide grove 37 with the aid of the linkages 41 to 44, and 46 to 48 of FIG. 7.

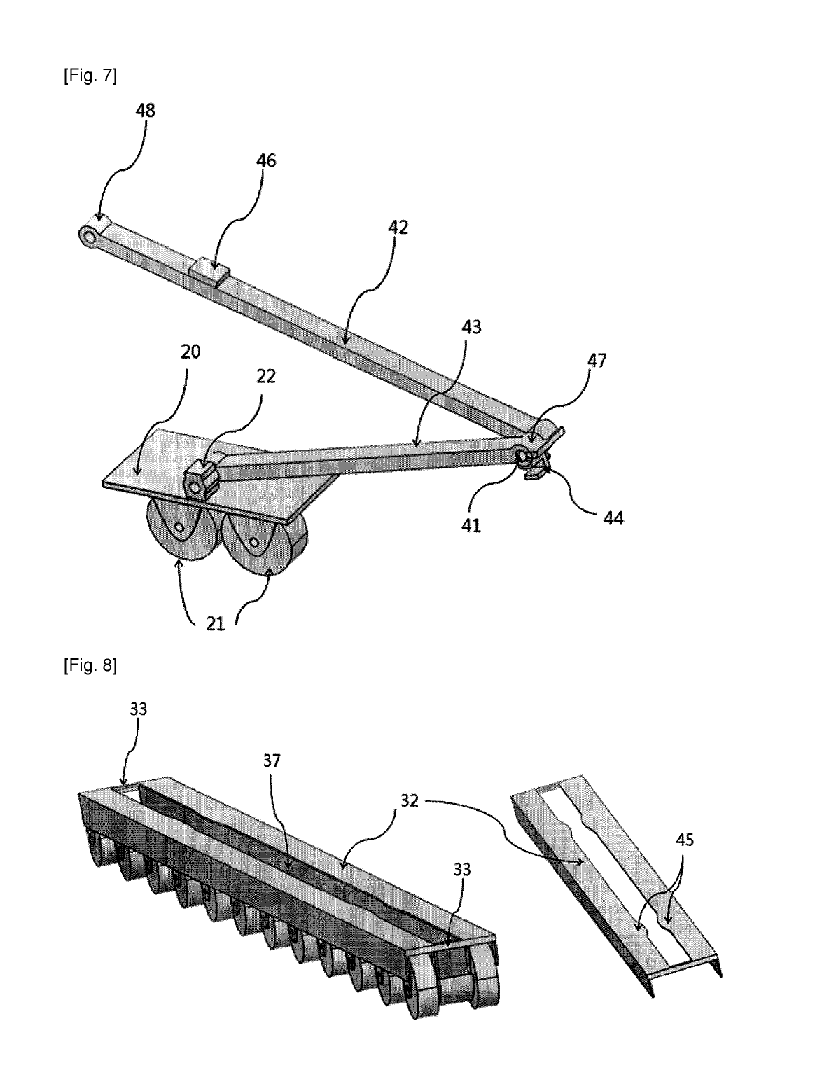

When the wheeled chassis 20 moves along with the top movable board 10, and the wheeled chassis 20 are caught by the end portion 33 of the transfer arm of FIGS. 6 and 8, the wheeled chassis 20 and the transfer arm 30 move together. Since a transfer arm stopper 36 is installed beneath the bottom of the transfer arm housing 34, when the transfer arm 30 starts moving along the transfer arm housing 34 and is caught by the transfer arm stopper 36, the transfer arm 30 no longer moves. The key features of the present invention do not need a process for installing and withdrawing the transfer arm 30. When the top movable board 10 moves in order to load or unload a patient, the wheeled chassis 20 secured at the top movable board moves a certain distance along the transfer arm 30, and then the wheeled chassis 20 and the transfer arm 30 move together a certain distance on the transfer arm housing 34 and the patient bed.

The transfer arm 30 serves in order for the top movable board 10 to easily move on the patient bed. U.S. Pat. No. 7,000,268 needs a complicated procedure for installing or withdrawing the transfer arm 30; however in the present invention an installing and withdrawing procedure of the transfer arm 30 are not needed because the transfer arm 30 moves with the aid of the wheeled chassis 20 when the top movable board 10 moves.

As shown in FIGS. 1 and 2, the top movable board 10 and the wheeled chassis 20 of FIG. 7 are connected by the linkages 41 to 44, 46 to 48, so a patient can be loaded or unloaded by tilting the top movable board 10 toward a patient. Since the top movable board 10 can be tilted toward beneath the patient's back, the patient can easily get on from the patient bed to the top movable board 10 without any difficulties. When it is needed to unload the patient, the top movable board 10 is tilted in one direction of the patient bed, so that the patient's body can naturally slide toward the patient bed.

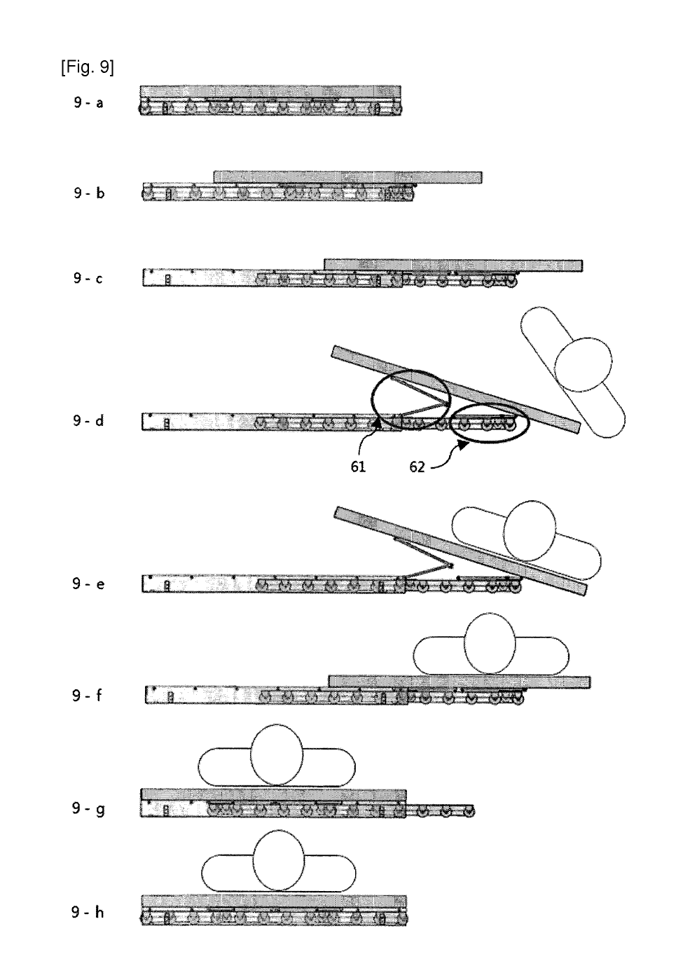

FIGS. 9, 10 and 11 views illustrating the procedures of loading and unloading the patient onto/from the patient bed. As shown in FIG. 9, when the top movable board 10 is moved as shown in FIG. 9 in order to load the patent from the patient bed to the patent movable bed, the wheeled chassis connected via the linkage 40 moves together, and when the wheeled chassis moved along the transfer arm 30 by a certain distance reaches the end portion 33 of the transfer arm, as shown in FIGS. 9B and 9C, the wheeled chassis 20 allows the transfer arm 30 to move outside the patient movable bed. Since the patient is not loaded, the transfer arm 30 can lightly move on the patient bed mattress.

As shown in FIG. 7, since the length of the linkage arm 42 of the upper side of the linkage connected with the top movable board 10 is longer than the length of the linkage arm 43 of the lower side, as shown in FIG. 9B, the wheeled chassis 20 connected with the linkage arm 43 of the lower side can move more along the wheeled chassis guide groove 37, so the top movable board 10 can be moved closer to the bed. When the top movable board 10 comes closer to the patient body, the top movable board 10 is tilted toward the patient body with the aid of the linkage 40. When the top movable board 10 is tilted toward the patient body, as shown in FIG. 9D, the linkage 61 distal from the patient body is unfolded, and the linkage 62 closer to the patient body does not tilter together since the linkage hook 44 of FIG. 7 is caught by the linkage hook holder 45 of FIGS. 6 and 8, so the linkage joint 48 connected with the top movable board 10 becomes the rotation pivot point of the top movable board 10. As shown in FIG. 9, when the linkage joint 48 of the upper side of the linkage 62 closer to the patient body becomes the rotation pivot point of the top movable board, and the patient leans against the top movable board 10, the weight center of the patient body becomes even closer to the center of the patient movable bed. When the patient leans against the top movable board 10, the top movable board 10 is naturally placed on the patient movable bed.

As shown in FIG. 9E, when the patient naturally lies down on the top movable board 10, the top movable board 10 is moved toward the patient movable bed, and as shown in FIG. 9F, the top movable board 10 starts moving on the transfer arm. At this time, since the top movable board 10 moves on the transfer arm 30 with the aid of the wheeled chassis 20, a lot of force is not needed to move the top movable board 10. When the top movable board 10 reaches the end portion 33 of another side of the transfer arm 30 along with the wheeled chassis 20, the weight center of the patient is moved from the patient bed to the patient movable bed, and as shown in FIG. 9G, the transfer arm 30 is not hard to withdraw on the patient bed mattress.

As shown in FIG. 9G, when the top movable board 10 can move further in the direction opposite to the patient bed, the transfer arm 30 can be fully withdrawn along the wheeled chassis 20 connected with the top movable board 10. Even when the top movable board 10 cannot further move in the direction opposite to the patient bed due to the side protection rail 50, since the patient body has been fully loaded toward the patient movable bed, the transfer arm can be fully withdrawn with a relatively small force as shown in FIG. 9H.

Since the transfer arm 30 is equipped with rollers, the transfer arm 30 can easily move on the patient bed mattress whereas when the patient body is lay on the top movable board 10, the transfer arm 30 is not easy move on the patient bed mattress due to the weight of a patient. In order to overcome the above problem, as key elements of the present invention, the wheeled chassis 20 is provided, which help the top movable board 10 to easily move on the transfer arm 30, and the length of the linkage arm 42 of the upper side is made longer than the linkage arm 43 of the lower side. When loading or unloading the patient from the patient movable bed, the transfer arm 30 is designed to move on the patient bed mattress only when the weight center of the top movable board 10 is positioned closer to the patient movable bed, so the transfer arm 30 can easily move on the patient bed mattress. The top movable board 10 and the transfer arm 30 are designed to move in both the left and right directions of the patient movable bed, which results in an easier use.

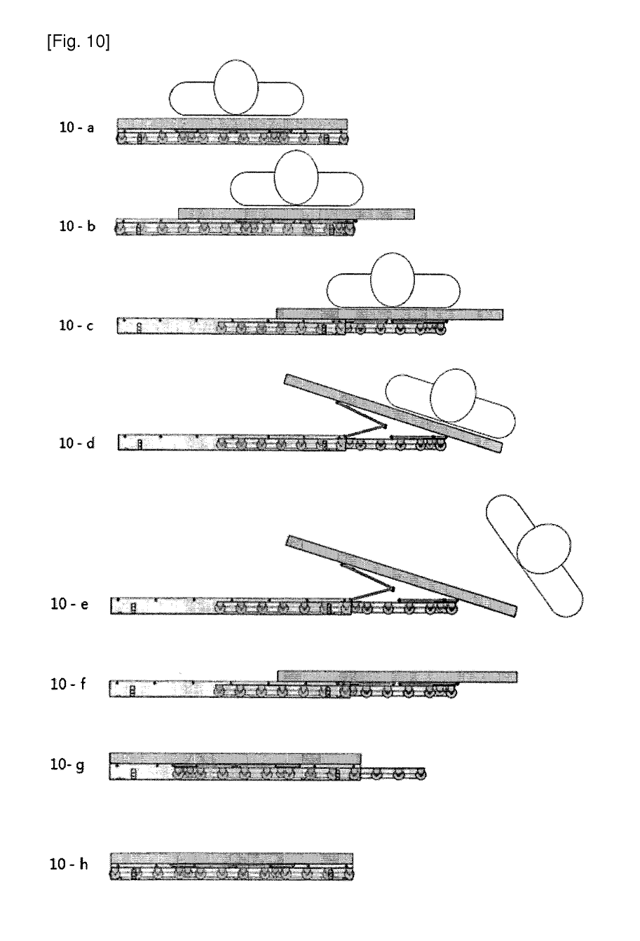

On the contrary, when unloading the patient from the patient movable bed, the patent movable bed is moved closer to one side of the patient bed, and as shown in FIGS. 10A and 10B, the top movable board 10 with the patient thereon is pushed toward the patient bed. As the top movable board 10 is moved toward the patient bed, the wheeled chassis is moved along the transfer arm 30, and the wheeled chassis 20 which has moved to the end portion 33 of one side of the transfer arm 30 move together with the transfer arm 30. As shown in FIG. 10E, as the top movable board 10 and the transfer arm 30 are fully moved toward the patient bed, and the top movable board 10 is tilted, the patient body naturally slides toward the patent bed. Once the patient body is moved to his bed, as shown in FIGS. 10F and 10G, as the top movable board is pushed toward the patient movable bed, it can be easily withdrawn together with the wheeled chassis and the transfer arm.

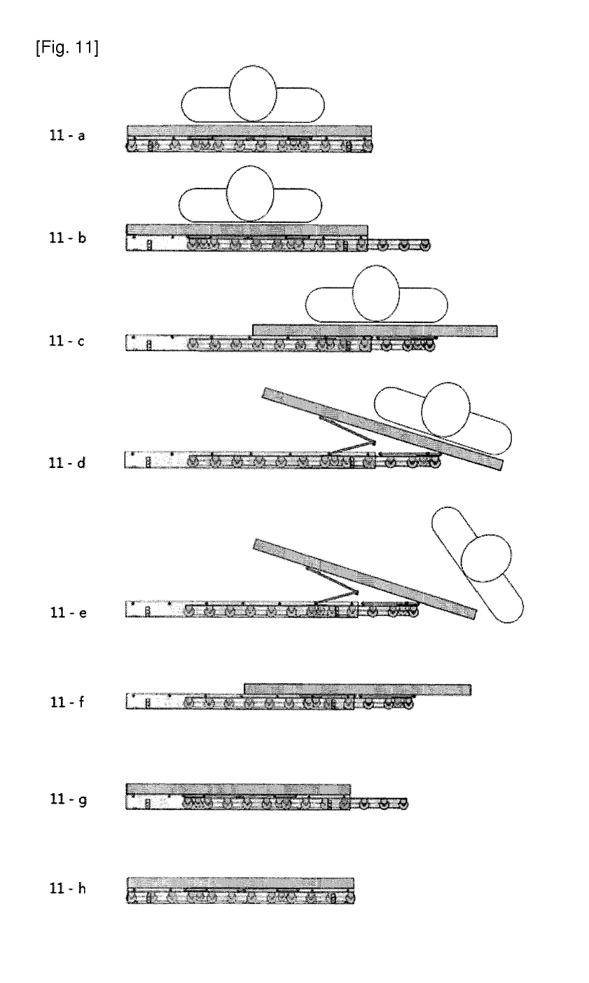

When the patient weights heavy, as shown in FIG. 10C, the transfer arm 30 supporting the weight of the patient might be hard to move due to the friction weight on the patient bed mattress. In this case, as shown in FIG. 11B, the transfer arm 30 is pulled out with hands and is installed at a proper distance on the patient bed, and as shown in FIG. 11C, when the top movable board 10 with the patient body thereon is pulled, the top movable board 10 can easily move on the transfer arm 30.

When a patient is supposed to move from the patient bed to the patient movable bed or vice versa, the safety of the patient movable bed is most important. In particular, since the weight center of the patient body moves, it is most important to prevent the patient movable bed from falling. When the patient movable bed comes closer to the patient bed in order to load or unload a patient to/from the patient movable bed, it is most important to secure the wheels 52 of the patient movable bed as shown in FIGS. 1 and 2 with the aid of the wheel lock apparatus of the patient movable bed. For more safety, the auxiliary legs can be installed on the patient movable bed during loading or unloading.

In the present invention, when the weight center of the patent moves out of the range of the patient movable bed, the transfer arm 30 is first placed on the patient bed mattress, so the transfer arm 30 serves to prevent the patient movable bed from falling due to the movement of the weight center of the patient body.

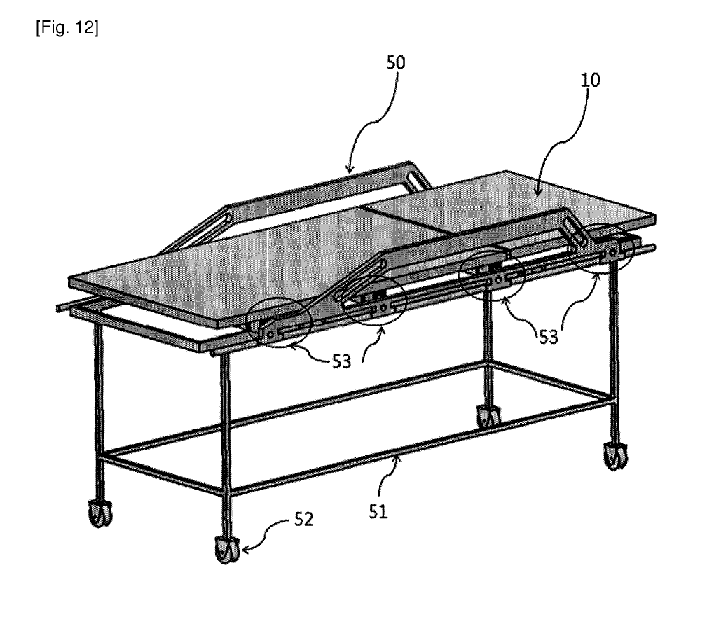

The side protection rails 50 of both sides of the patient movable bed are lifted as shown in FIG. 12 before the patient movable bed is moved after the patient body is loaded on the patient movable bed, thus securing the movement of the top movable board 10. The side protection rail 50 serves to prevent the patient body from falling from the patient movable bed when the patient is moved and serves to secure the movement of the top movable board 10 and the transfer arm 30 with the aid of the lower support part 53 of the side protection rail of FIG. 12.

When the top movable board 10 is moved as shown in FIGS. 9B and 9C in order to load the patient, since the top movable board 10 does not yet have the patient body thereon, the transfer arm 20 is light, so it can move easily. When the patient body is loaded on the top movable board 10, as shown in FIGS. 9F and 9G, the top movable board 10 moves along the previously installed transfer arm 30 with the aid of the wheeled chassis 20, and when the top movable board 10 has fully moved toward the patient movable bed, since most parts of the patient body have been moved to the patient movable bed, the transfer arm 30 can be easily withdrawn. Therefore, the transfer arm 30 does not need a separate installation and withdrawal procedure, but can be easily installed or withdrawn along with the top movable board 10.

The key features of the present invention lie in that some apparatuses such as the transfer arm 30 or the like do not need installation or withdrawal procedures. The advantages of the present invention can be obtained in such a way that as shown in FIG. 9, the top movable board 10 is pulled from the patient movable bed toward the patient, and the patient is loaded to the top movable board 10, and the top movable board 10 is pushed toward the patient movable bed, so it is possible to easily move the patient to the patient movable bed without hard works. When it is supposed to unload the patient from the patient movable bed to the patient bed, a certain procedure for installing certain apparatus is not needed. As shown in FIGS. 10 and 11, the top movable board 10 is simply pulled toward the patient bed, thus unloading the patient, and then the top movable board is pushed toward the patient movable bed, so it is possible to easily unload the patient from the patient movable bed to the patient bed without hard work.

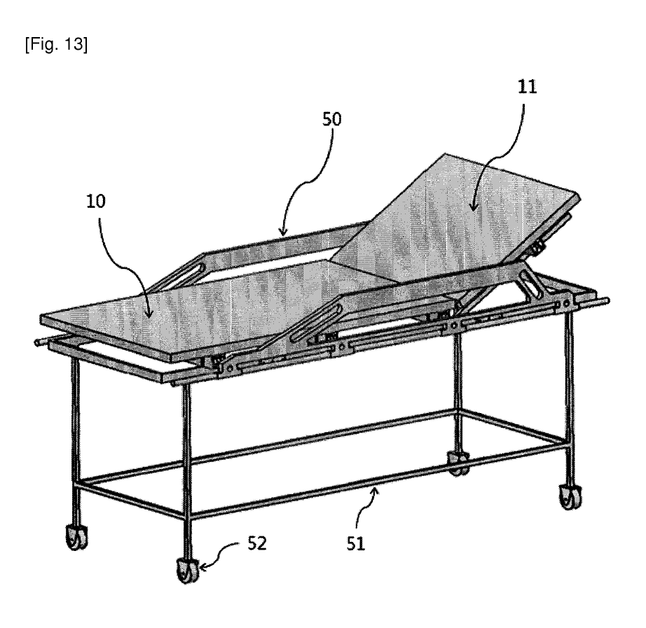

The transfer arm 30 is connected with the patient movable bed frame via the transfer arm housing 34. The patient movable bed frame with the transfer arm housing 34 installed therein might help to erect the top movable board driving part 11 with a joint or the like as shown in FIG. 13. When the patient needs to wait for a long time on the patient movable bed, the patient might take a rest in a more comfortable posture by erecting the top movable board driving part 11.

A slider is installed below the frame with the transfer arm housing 34 installed therein, so the patient transfer apparatus formed of a top movable board, a linkage, a wheeled chassis, a guide rail, a guide rail housing, etc. can come closer to the patient bed.

### INDUSTRIAL APPLICABILITY

The present invention is applicable to the patient movable bed which is generally used when moving a patient laying on a patient bed in a patient room to a medical diagnosis room or a check room or when moving a patient from a medical diagnosis room and a check room to a patient bed in a patient room.

In the present invention, since it is possible to easily load or unload the patient to/from the patient movable bed in such a way to turn over from a lying down posture to a posture of lying on his side, thus minimizing any inconveniences which might occur whenever a patient moves, and the patient can be easily moved with a small number of persons.

The present invention makes it possible to minimize any inconveniences which used to occur during the transfer of a heavy patient. In recent years, fatty persons increase day by day, so it is expected that the applicability of the present invention significantly increases. Since the present invention does not need an external force for a patient transfer, and an installation and withdrawal of further apparatuses are not needed, and the operation is easy, and the construction of the apparatus is simple, so the apparatus of the present invention is not costly.

1. A patient transfer apparatus, comprising:
a top movable board for carrying a patient body thereon;
a wheeled chassis connected with the top movable board;
a transfer arm which is movable on a patient bed mattress, while allowing the wheeled chassis to run; and
a transfer arm housing connected with a patient movable bed frame in order for the transfer arm to move.

2. A patient transfer apparatus of claim 1, wherein a linkage is installed between the top movable board and the wheeled chassis so that the top movable board can tilt to help easily load or unload a patient body to/from the top movable board.

3. A patient transfer apparatus of claim 2, wherein a rotation pivot point of the top movable board and a distance of the wheeled chassis that the transfer arm can move can be adjusted by adjusting the length of the linkage arm of the lower side connected to the wheeled chassis and the length of the linkage arm of the upper side connected to the top movable board, respectively.

4. A patient transfer apparatus of claim 2, wherein a linkage joint has a linkage hook, by which the linkage joint is secured at a linkage hook holder when the top movable board is tilted for loading or unloading a patient body.

5. A patient transfer apparatus of claim 2 wherein an over rotation prevention apparatus (stopper) is connected with a linkage arm connection joint for thereby preventing an angle between two linkage arms from exceeding 180°.

6. A patient transfer apparatus of claim 1, wherein a transfer arm stopper is installed between the transfer arm and the transfer arm housing to prevent the transfer arm from escaping a certain distance.

7. A patient transfer apparatus of claim 1, wherein the lower support part of the side protection rail is installed, which prevents the wheeled chassis or the transfer arm from escaping from the bed when moving with the patient body therein.

8. A patient transfer apparatus of claim 1, wherein a top movable board driving part is installed, which a patient's fatigue in such a way to erect part of the top movable board when a patient needs to stay a long time on the patient movable bed.
